(19) United States
(12) Patent Application Publication
(10) Pub. No.: US 2005/0086120 A1
(43) Pub. Date: Apr. 21, 2005

(54) Method of managing subcontracting for backend outsourcing business

(75) Inventors: Tu Shao-Chi, Hsin-Chu City (TW); Tsai Jung-Yi, Hsin-Chu City (TW)

Correspondence Address: HAYNES AND BOONE, LLP, 901 MAIN STREET, SUITE 3100, DALLAS, TX, 75202, US

(73) Assignee: Taiwan Semiconductor Manufacturing Co., Ltd., Hsin-Chu (TW)

(21) Appl. No.: 10/687,224

(22) Filed: Oct. 16, 2003

(51) Int. Cl. G06F 17/60

(52) U.S. Cl. 705/26; 705/28

(57) ABSTRACT

The present disclosure provides a method of business-to-business exchange between customers in a semiconductor manufacturing environment. In one embodiment, the method includes exchanging a product from a primary provider to a secondary provider, assigning event elements to the product through a virtual fab, and transmitting information associated with the product throughout the virtual fab, wherein the transmission of information occurs multi-directionally between the entities of the virtual fab and controlling the flow of information and the product through the virtual fab. The controlling flow is multi-directional throughout the virtual fab.

### FIELD OF DISCLOSURE

The present disclosure relates generally to a method of business-to-business exchange between customers and providers in a semiconductor manufacturing environment, more particularly, to a business-to-business enterprise control system in a semiconductor manufacturing environment.

### BACKGROUND

The semiconductor integrated circuit (IC) industry has experienced rapid growth. Technological advances in IC materials and design have produced generations of ICs where each generation has smaller and more complex circuits than the previous generation. However, these advances have increased the complexity of processing and manufacturing ICs and, for these advances to be realized, similar developments in IC processing and manufacturing have been needed. For example, an IC is formed by creating one or more devices (e.g., circuit components) on a substrate using a fabrication process. As the geometry of such devices is reduced to the submicron or deep submicron level, the IC's active device density (i.e., the number of devices per IC area) and functional density (i.e., the number of interconnected devices per IC area) has become limited by the fabrication process.

Furthermore, as the IC industry has matured, the various operations needed to produce an IC may be performed at different locations by a single company or by different companies that specialize in a particular area. This further increases the complexity of producing ICs, as providers, their customers and their other, related providers may be separated not only geographically, but also by time zones, making effective communication more difficult. For example, a first provider (e.g., an IC design house) may design a new IC, a second provider (e.g., an IC foundry) may provide the processing facilities used to fabricate the design, and a third provider may assemble and test the fabricated IC. A fourth provider may handle the overall manufacturing of the IC, including coordination of the design, processing, assembly, and testing operations.

The complexity of process steps and time-consuming process of manufacturing advanced semiconductor devices mandates efficient processing systems and methods, specifically the business-to-business (B2B) transactions between a front end semiconductor manufacturer to a backend semiconductor manufacturer.

The quality and process control methods can be different between a front end manufacturer and a backend manufacturer. Communication between the two manufacturers can be difficult since the manufacturing systems may be different and may utilize different identification parameters.

Accordingly, what is needed in the art is a system and method thereof that addresses the above-discussed issues.

### SUMMARY

The present disclosure provides a system, method, and software program for business-to-business exchange between customers and/or providers in a semiconductor manufacturing environment. In one embodiment, a novel enterprise control system can be used in an environment for producing semiconductor-related product. The enterprise control system includes a first mechanism for maintaining an exchange of information between a primary provider and a secondary provider, the information pertaining to the semiconductor-related product. The enterprise control system also includes a second mechanism for collecting the exchanged information, a third mechanism for collecting event information upon an occurrence of a predetermined event element associated with the semiconductor-related product, and a fourth mechanism for providing the collected exchanged information and the collected event information to a customer associated with the semiconductor-related product.

In another embodiment, the enterprise control system further includes a fifth mechanism for assigning the predetermined event element to the semiconductor-related product at the secondary provider.

In another embodiment, a system is provided for business-to-business exchange between entities in a semiconductor manufacturing environment. The system includes a product with exchangeable information interposing a primary provider and a secondary provider, a plurality of event elements assigned to the product through a virtual fab, and an enterprise control entity adapted for the exchange of information associated with the product through the virtual fab. The enterprise control entity is also adapted to provide multi-directional information manipulation throughout the virtual fab.

In one embodiment, a method is provided for business-to-business exchange between providers in a semiconductor manufacturing environment. The method includes exchanging a product from a primary provider to a secondary provider and transmitting information associated with the product throughout a virtual fab. The transmission of information can occur continuously and multi-directionally between the providers through the virtual fab. The method also includes storing at least a portion of the transmitted information and providing the portion of the transmitted information to a customer in response to a customer request.

In one embodiment, a software program stored on a recordable medium is provided. The software program can be used for tracking and managing a plurality product and information through a semiconductor manufacturing environment. The software program includes instructions for establishing a virtual fab with a plurality of entities, each entity associated with an internal process to a semiconductor fab or an external process to the semiconductor fab. The software program also includes instructions for a plurality of event elements for tracking the product through the plurality of entities of the virtual fab, instructions for a communications interface for interacting with a enterprise control entity and the plurality of event elements, instructions for determining a future location for the product and the associated information through the virtual fab via the enterprise control entity, and instructions for amending the associated information to the recordable medium through the virtual fab.

The foregoing has outlined preferred and alternative features of several embodiments so that those skilled in the art may better understand the detailed description that follows. Additional features will be described below that further form the subject of the claims herein. Those skilled in the art should appreciate that they can readily use the present disclosure as a basis for designing or modifying other methods and systems for carrying out the same purposes and/or achieving the same advantages of the embodiments introduced herein. Those skilled in the art should also realize that such equivalent constructions do not depart from the spirit and scope of the present disclosure.

### BRIEF DESCRIPTION OF THE DRAWINGS

The present disclosure is best understood from the following detailed description when read with the accompanying figures. It is emphasized that, in accordance with the standard practice in business practices, various steps are not executed in specific orders. In fact, the entities associated with the systems and methods discussed are for clarity of discussion.

FIG. 1 illustrates a block diagram view of the embodiment of the system for managing business-to-business data exchange in a semiconductor manufacturing environment.

FIG. 2 illustrates a schematic view of one embodiment of a virtual IC fabrication system constructed according to aspects of the present disclosure.

FIG. 3 illustrates a schematic view of one embodiment of the virtual fab including a plurality of entities of FIG. 2 constructed according to the aspects of the present disclosure.

FIG. 4 illustrates a flow chart view of one embodiment of a method for providing a managed business-to-business data exchange constructed according to the aspects of the present disclosure.

FIG. 5 illustrates an interface of another embodiment by which a customer may interact with the managed business-to-business semiconductor data exchange system of FIG. 1.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the relationship of a first entity with a second entity in the description that follows may include embodiments in which the first and second entities are in direct contact, and may also include embodiments in which additional entities may be interposing the first and second entity, such that the first and second entity may not be in direct contact.

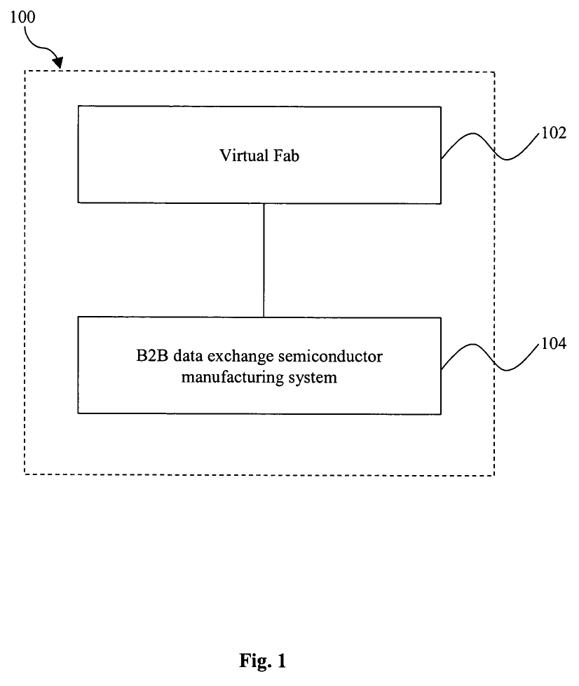

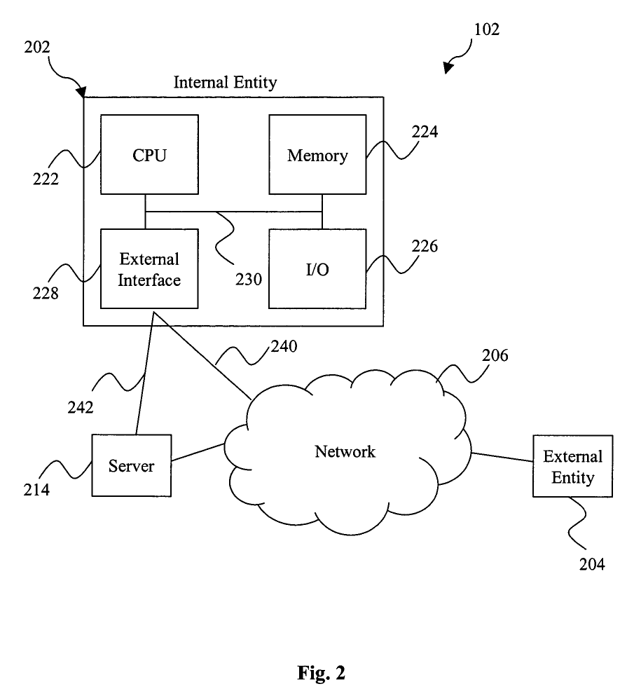

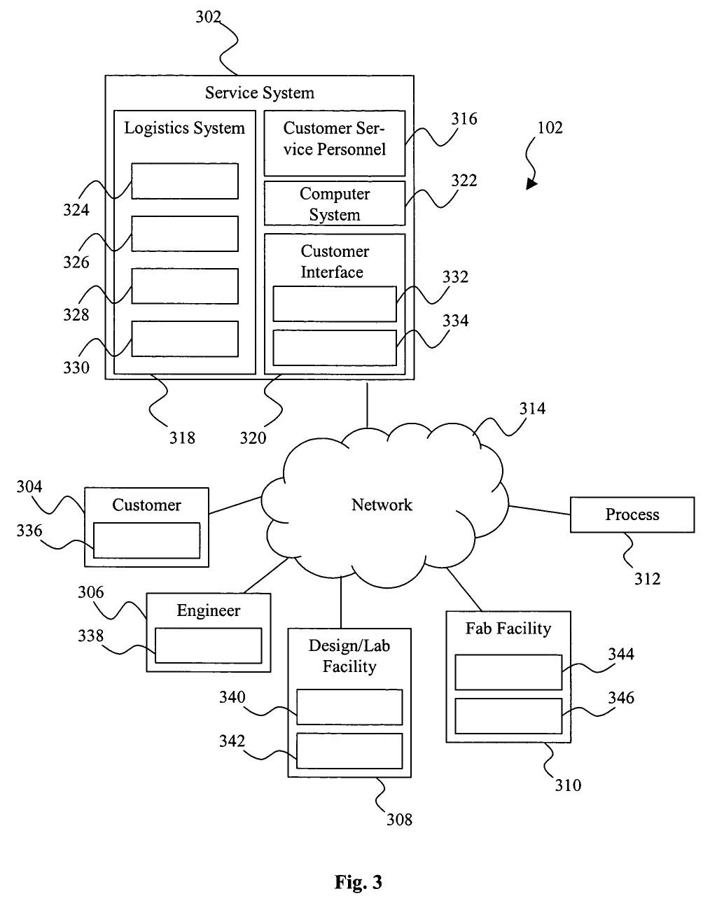

Referring to FIG. 1, in one embodiment, a system 100 for managing business-to-business (B2B) data exchange in a semiconductor manufacturing environment is provided according to aspects of the present disclosure. The system 100 may include two components: a virtual IC fabrication system (a “virtual fab”) 102 and a B2B semiconductor data exchange system 104. The virtual fab 102, which is discussed in greater detail below with respect to FIGS. 2-3, is a combination of hardware, software, and/or communication equipment configured to support communications between various “entities” associated with the manufacture of “IC devices.” The term IC devices is broadly defined to include various stages of manufacture. For example, the IC devices being manufactured may be fully tested chips, or may only be untested semiconductor wafers.

The B2B semiconductor data exchange system 104 is also a combination of hardware, software, and/or communication equipment configured to support communications between one or more entities of the virtual fab 102 and various providers of the manufactured IC devices. A provider is an entity that provides some type of goods and/or services for the manufacture of the IC devices. A customer is an entity that is ordering, purchasing, requesting, or considering the purchase of IC devices, or is otherwise overseeing or monitoring some aspect of the manufacture of the IC devices. In many embodiments, a single entity is both a provider and a customer. For example, a company can provide a circuit design to a semiconductor foundry for manufacturing a plurality of fully tested chips, thus making the company both a provider and a customer.

The B2B semiconductor data exchange system 104 can facilitate managing some or all process steps of an entity such as a secondary manufacturer and managing the exchange of information services between one or more customers and/or providers. The B2B semiconductor data exchange system 104 may also provide a common vehicle that spans some or all entities of the virtual fab 102, thereby allowing one or more customers to initiate, track, and receive product data between the entities. For example, the common vehicle can include a myriad of software programs comprising a enterprise control entity. The enterprise control entity can provide automatic information collection, information management of information, and direct and continuous transmission between a provider and a customer. The B2B semiconductor data exchange system 104 may employ methods and systems which can be shared between customers, providers, or combinations thereof, such as foundries, assembly facilities, sub-contractors, and other semiconductor manufacturing support systems, such as equipment vendor support. The sharing of process or status information of semiconductor product manufacturing can improve manufacturing efficiency, reduce cycle time of the manufacturing, and provide standardization of product identification and work in progress.

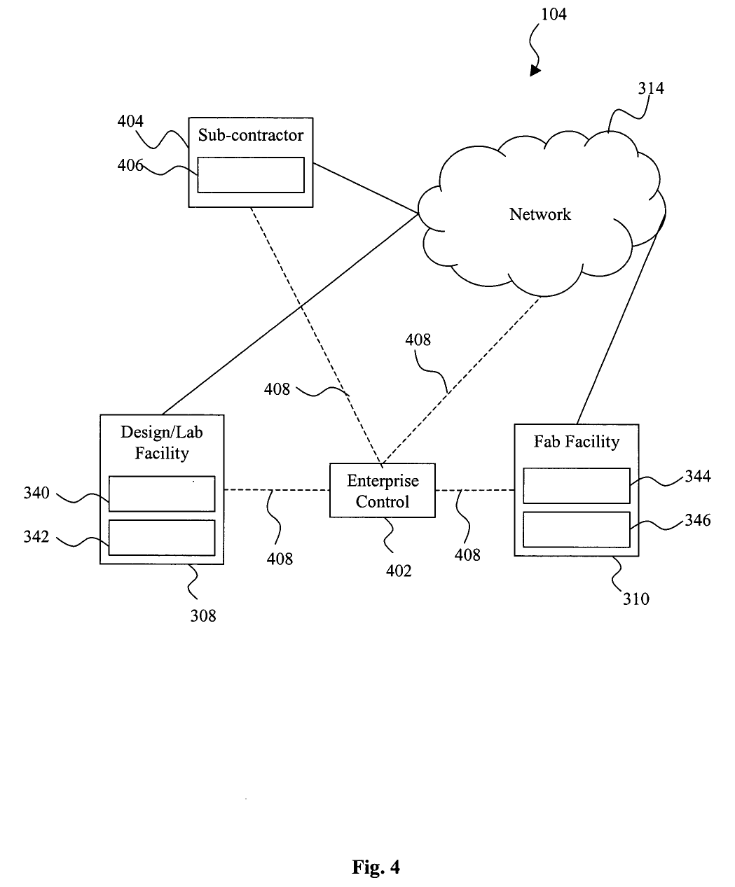

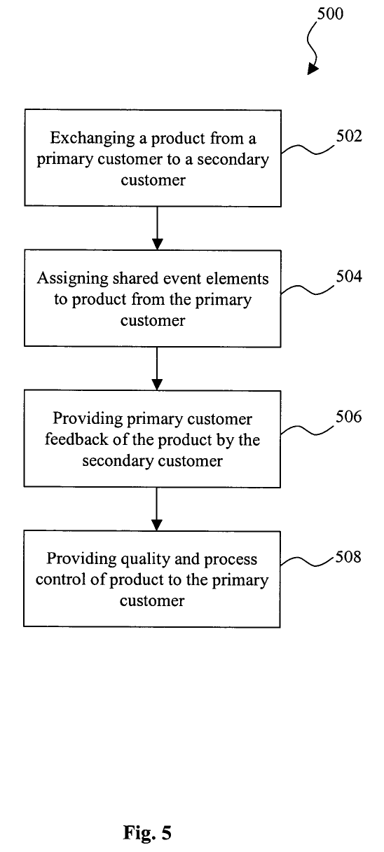

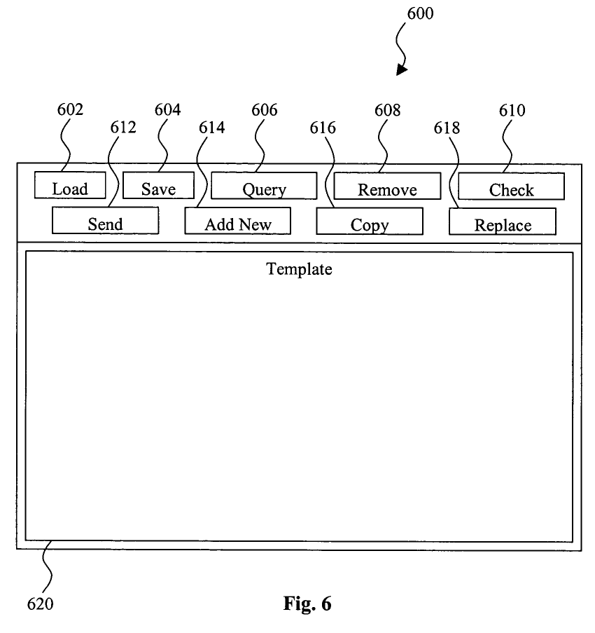

Interaction and control of the B2B semiconductor data exchange system 104 can be performed through the network facilities of the virtual fab component 102, discussed below with reference to FIGS. 2-3, utilizing techniques discussed below with reference to FIGS. 4-5. Alternatively, the B2B semiconductor data exchange system 104 may utilize network facilities that are separate from the virtual fab component 102, or a combination thereof.

The Virtual Fab

Referring now to FIG. 2, one embodiment of the virtual fab 102 includes a plurality of entities, represented by one or more internal entities 202 and one or more external entities 204 that are connected by a communications network 206. The network 206 may be a single network or may be a variety of different networks, such as an intranet and the Internet, and may include both wireline and wireless communication channels.

Each of the entities 202, 204 may include one or more computing devices such as personal computers, personal digital assistants, pagers, cellular telephones, and the like. For the sake of example, the internal entity 202 is expanded to show a central processing unit (CPU) 222, a memory unit 224, an input/output (I/O) device 226, and an external interface 228. The external interface may be, for example, a modem, a wireless transceiver, and/or one or more network interface cards (NICs). The components 222-228 are interconnected by a bus system 230. It is understood that the internal entity 202 may be differently configured and that each of the listed components may actually represent several different components. For example, the CPU 222 may actually represent a multi-processor or a distributed processing system; the memory unit 224 may include different levels of cache memory, main memory, hard disks, and remote storage locations; and the I/O device 226 may include monitors, keyboards, and the like.

The internal entity 202 may be connected to the communications network 206 through a wireless or wired link 240, and/or through an intermediate network 242 and/or server 214, which may be further connected to the communications network. The intermediate network 242 may be, for example, a subnet of a local area network, a company wide intranet, and/or the Internet. The internal entity 202 may be identified on one or both of the networks 206, 242 by an address or a combination of addresses, such as a media control access (MAC) address associated with the network interface 228 and an internet protocol (IP) address. Because the internal entity 202 may be connected to the intermediate network 242, certain components may, at times, be shared with other internal entities. Therefore, a wide range of flexibility is anticipated in the configuration of the internal entity 202. Furthermore, it is understood that, in some implementations, a server 244 may be provided to support multiple internal entities 202. In other implementations, a combination of one or more servers and computers may together represent a single entity.

In the present example, the internal entities 202 represents those entities that are directly responsible for producing the end product, such as a wafer or individually tested IC devices. Examples of internal entities 202 include an engineer, customer service personnel, an automated system process, a design or fabrication facility and fab-related facilities such as raw-materials, shipping, assembly or test. Examples of external entities 204 include machine or raw material provider to the fab, a design provider, and other facilities that are not directly associated or under the control of the fab. In addition, additional fabs and/or virtual fabs can be included with the internal or external entities. Each entity may interact with other entities and may provide services to and/or receive services from the other entities.

It is understood that the entities 202-204 may be concentrated at a single location or may be distributed, and that some entities may be incorporated into other entities. In addition, each entity 202, 204 may be associated with system identification information that allows access to information within the system to be controlled based upon authority levels associated with each entities identification information.

The virtual fab 102 enables interaction among the entities 202-204 for purposes related to IC manufacturing, as well as the provision of services. In the present example, IC manufacturing can include one or more of the following steps:
receiving or modifying a customer's order of price, delivery, and/or quantity;
receiving or modifying an IC design;
receiving or modifying a process flow;
receiving or modifying a circuit design;
receiving or modifying a mask change;
receiving or modifying testing parameters;
receiving or modifying assembly parameters; and
receiving or modifying shipping of the ICs.

One or more of the services provided by the virtual fab 102 may enable collaboration and information access in such areas as design, engineering, and logistics. For example, in the design area, the customer 204 may be given access to information and tools related to the design of their product via the fab 202. The tools may enable the customer 204 to perform yield enhancement analysis, view layout information, and obtain similar information. In the engineering area, the engineer 202 may collaborate with other engineers 202 using fabrication information regarding pilot yield runs, risk analysis, quality, and reliability. The logistics area may provide the customer 204 with fabrication status, testing results, order handling, and shipping dates. It is understood that these areas are exemplary, and that more or less information may be made available via the virtual fab 102 as desired.

Another service provided by the virtual fab 102 may integrate systems between facilities, such as between a facility 204 and the fab facility 202. Such integration enables facilities to coordinate their activities. For example, integrating the design facility 204 and the fab facility 202 may enable design information to be incorporated more efficiently into the fabrication process, and may enable data from the fabrication process to be returned to the design facility 204 for evaluation and incorporation into later versions of an IC.

Referring now to FIG. 3, another embodiment of the virtual fab 102 includes a plurality of entities 302, 304, 306, 308, 310, and 312 that are connected by a communications network 314. In the present example, the entity 302 represents a service system, the entity 304 represents a customer, the entity 306 represents an engineer, the entity 308 represents a design/lab facility for IC design and testing, the entity 310 represents a fab facility, and the entity 312 represents a process (e.g., an automated fabrication process) either inside the fab 310, or at another facility. Each entity may interact with other entities and may provide services to and/or receive services from the other entities.

The service system 302 provides an interface between a customer's internal system (e.g., a computer database) and the IC manufacturing operations. For example, the service system 302 may include customer service personnel 316, a logistics system 318 for order handling and tracking, and a customer interface 320 for enabling a customer to directly access various aspects of an order.

The logistics system 318 may include a work-in-process (WIP) inventory system 324, a product data management system 326, a lot control system 328, and a manufacturing execution system (MES) 330. The WIP inventory system 324 may track working lots using a database (not shown). The product data management system 326 may manage product data and maintain a product database (not shown). The product database could include product categories (e.g., part, part numbers, and associated information), as well as a set of process stages that are associated with each category of products. The lot control system 328 may convert a process stage to its corresponding process steps.

The MES 330 may be an integrated computer system representing the methods and tools used to accomplish production. In the present example, the primary functions of the MES 330 may include collecting data in real time, organizing and storing the data in a centralized database, work order management, workstation management, process management, inventory tracking, and document control. The MES 330 may be connected to other systems both within the service system 302 and outside of the service system 302. Examples of the MES 330 include Promis, Workstream, Poseidon, and Mirl-MES. Each MES may have a different application area. For example, Mirl-MES may be used in applications involving packaging, liquid crystal displays (LCDs), and printed circuit boards (PCBs), while Promis, Workstream, and Poseidon may be used for IC fabrication and thin film transistor LCD (TFT-LCD) applications. The MES 330 may include such information as a process step sequence for each product.

The customer interface 320 may include an online system 332 and an order management system 334. The online system 332 may function as an interface to communicate with the customer 304, such as through email or other electronic means. The online system 332 may also function as an interface to other systems within the service system 302, supporting databases (not shown), and other entities 306-312. The order management system 334 may manage client orders and may be associated with a supporting database (not shown) to maintain client information and associated order information.

Portions of the service system 302, such as the customer interface 320, may be associated with a computer system 322 or may have their own computer systems. In some embodiments, the computer system 322 may include multiple computers (FIG. 4), some of which may operate as servers to provide services to the customer 304 or other entities. The service system 302 may also provide such services as identification validation and access control, both to prevent unauthorized users from accessing data and to ensure that an authorized customer can access only their own data.

The customer 304 may obtain information about the manufacturing of its ICs via the virtual fab 102 using a computer system 336. In the present example, the customer 304 may access the various entities 302, 306-312 of the virtual fab 102 through the customer interface 320 provided by the service system 302. However, in some situations, it may be desirable to enable the customer 304 to access other entities without going through the customer interface 320. For example, the customer 304 may directly access the fab facility 310 to obtain fabrication related data.

The engineer 306 may collaborate in the IC manufacturing process with other entities of the virtual fab 102 using a computer system 338. The virtual fab 102 enables the engineer 306 to collaborate with other engineers and the design/lab facility 308 in IC design and testing, to monitor fabrication processes at the fab facility 310, and to obtain information regarding test runs, yields, etc. In some embodiments, the engineer 306 may communicate directly with the customer 304 via the virtual fab 102 to address design issues and other concerns.

The design/lab facility 308 provides IC design and testing services that may be accessed by other entities via the virtual fab 102. The design/lab facility 308 may include a computer system 340 and various IC design and testing tools 342. The IC design and testing tools 342 may include both software and hardware.

The fab facility 310 enables the fabrication of ICs. Control of various aspects of the fabrication process, as well as data collected during the fabrication process, may be accessed via the virtual fab 102. The fab facility 310 may include a computer system 344 and various fabrication hardware and software tools and equipment 346. For example, the fab facility 310 may include an ion implantation tool, a chemical vapor deposition tool, a thermal oxidation tool, a sputtering tool, and various optical imaging systems, as well as the software needed to control these components.

The process 312 may represent any process or operation that occurs within the virtual fab 102. For example, the process 312 may be an order process that receives an IC order from the customer 304 via the service system 302, a fabrication process that runs within the fab facility 310, a design process executed by the engineer 306 using the design/lab facility 308, or a communications protocol that facilities communications between the various entities 302-312.

It is understood that the entities 302-312 of the virtual fab 102, as well as their described interconnections, are for purposes of illustration only. For example, it is envisioned that more or fewer entities, both internal and external, may exist within the virtual fab 102, and that some entities may be incorporated into other entities or distributed. For example, the service system 302 may be distributed among the various entities 306-310.

The B2B Seminconductor Data Exchange System.

The B2B semiconductor data exchange system 104 can be implemented on hardware and/or software components of the virtual fab 102. For example, software can run on one or more components of the virtual fab, such as the computer systems 336 322, and/or 344 of FIG. 3. In embodiments where the network 314 is accessible to the customer, such as the Internet, the network 314 can be used to distribute any necessary software and/or hardware of the B2B semiconductor data exchange system 104. In alternative embodiments, the B2B semiconductor data exchange system 104 may utilize, at whole or in part, dedicated software and/or hardware components. For the sake of the present embodiments, the components of the virtual fab 102 will be further discussed.

Referring now to FIG. 4, an embodiment of the B2B semiconductor data exchange system 104 includes a plurality of entities 308, 310, and 404 that are connected by the communications network 314. The entity 308 represents a design/lab facility for IC design and testing, the entity 310 represents a fab facility, entity 402 represents a enterprise control, and the entity 404 represents a sub-contractor. Each entity may interact with other entities and may provide services to and/or receive services from the other entities.

The enterprise control entity 402 adapts information associated with the product for exchange through the virtual fab 102, the enterprise control entity 402 is adapted to provide multi-directional information manipulation throughout the virtual fab 102. The enterprise control entity 402 can comprise a plurality of software programs which can provide automatic information exchange between the entities 308, 310, and 404 through the network 314. The enterprise control entity 402 can provide a direct connection 408 between the entities 308, 310, 404, and the network 314 wherein transmission of information over the direct connection(s) 408 can be continuous or in packets. The direct connection(s) 408 may represent a separate, secure network, such a virtual private network, used for sharing information. Alternatively, the direct connection(s) 408 may represent a specific network path through the same networks 314, 206 used by the virtual fab. Although not required, if the direct connection(s) 408 use a public network such as the Internet, a system and method for maintaining a secure and continuous transmission pathway may be desired.

A continuous transmission through the direct connection 408 can allow information and data to be transmitted within pico-second, micro-second, multiple minute, multiple hour, and/or multiple day interval events. The information managed by the enterprise control entity 402 can include product lot identification, product lot history, electrical probe data, product cycle time, product check point status, and a myriad of other information which can be understood to be managed between the entities 308, 310, and 404.

The sub-contractor entity 404 can include a plurality of computer system(s) 406 having software programs and networking equipment which can be non-synonymous with the software programs and networking equipment of the IC design/lab facility and testing entity 308, the fab facility entity 310, or a myriad of other entities coupled to the network 314 of the virtual fab 102. The enterprise control entity 402 adapts the non-synonymous software programs and networking equipment through the direct connection 408 which can include fast transfer protocols (FTP) and a plurality of other commonly employed electronic information streaming methods well known by one skilled in the art.

Referring now to FIG. 5, in one embodiment, the B2B semiconductor data exchange system 104 (FIG. 1) may implement a method 500 to facilitate communications between one or more customers and one or more entities of the virtual fab 102. The method 500 begins at step 502 by providing a product from a primary provider to a secondary provider. The primary provider can be an entity that produces a good or service that is used by a secondary provider. For example, the primary provider may be a design house and the secondary provider may be a fab. In another example, the primary provider is the fab and the secondary provider is the backend semiconductor packaging company, sub-contractor, or equipment vendor. The primary provider may provide product material to the secondary provider. For the sake of the present discussion, the primary provider provides a plurality of semiconductor substrates with a plurality of complex integrated circuits. The substrates are semiconductor wafers having a plurality of die fabricated thereupon. The die, or individual semiconductor devices, may be sliced and partitioned from the wafer by the secondary provider and can be further packaged, assembled, and tested.

Next, at step 504, a plurality of shared event elements can be assigned by the primary provider. The shared event elements may correspond to critical process steps that may be carried out by the secondary provider and can be controlled and monitored through the network 314 of the virtual fab 102 by any of the internal entities 202 and external entities 204. The shared event elements can include recordable or defined product-specific process parameters and status of work-in-progress at the secondary provider. Shared event elements can include recordable parameters further including event times for wafer quantity received and shipped, actual yielding die, start wafer quantity, lost quantity, and any other process recordable data. The shared event elements can be linked to process steps which may be monitored through the network 314 by the primary provider or foundry.

At step 506, real-time feedback is provided to the primary provider of the product status from the secondary provider. The B2B semiconductor data exchange system 104 can be coupled to the primary provider and a plurality of other sub-contractors, equipment vendors, or foundries. The products that may be monitored can include semiconductor wafer lots, rectangular substrates such as LCD or plasma display lots, or any other batch aggregate of electronic devices. Step 506 can provide feedback as a continuous stream of data or in multiple packets according to any specified time interval. Data can include abnormality alerts, time delay alerts, notification of split lots, notification of scrapped parts, process status, yield notifications, cycle time, and any other recordable data which can be transmitted through the network 314 of the virtual fab 102.

Control of the product quality and process may be shared and distributed to the primary provider and the secondary provider at step 508. The B2B semiconductor data exchange system 104 can provide sharing of the process and quality control between internal entities 202 and external entities 204. The B2B semiconductor data exchange system 104 may also designate a facilitator of quality and process control, such as the primary provider (e.g., the foundry).

Referring now to FIG. 6, an interface 600 illustrates one embodiment by which a primary provider, secondary provider, internal entities 202, and external entities 204 may interact with the B2B semiconductor data exchange system 104 of FIG. 1. It is understood that a variety of interfaces may be presented to the customer, such as a login interface and a help interface that provides the customer with instructions on how to accomplish various tasks. After the customer logins to the B2B semiconductor data exchange system 104, the interface 600 presents the customer with several options. In the present example, the interface 600 includes a Load button 602, a Save button 604, an Query button 606, a Remove button 608, a Check button 610, an Send button 612, an Add New button 614, a Copy button 616, and a Replace button 618. The interface 600 may also include a template 620 that provides the customer with a information regarding product and process status. The template 620 may be updated by a job request specification during the design process to ensure that the job request is correct. Alternatively, the B2B semiconductor data exchange system 104 may be applied to the template 620. The template 620 may further represent a browser screen, a plurality of selection screens, and a real-time B2B semiconductor data exchange system 104 tracking and control screens.

The Load and Save buttons 602, 604 provide the customer with the option to either load product data and information built-in from the primary provider or secondary provider and the B2B semiconductor data exchange system 104 through the network 314. The Query button 606 may search for foundry device information, mask design, and other technical specification databases. The Remove button 608 enables the customer to remove a component or information from the job request, while the Check button 610 enables the system 100 to check the customer input and output data. For example, activating the Check button 612 may be used for initiating an automated monitoring process for collecting process and product data through the B2B semiconductor data exchange system 104. The Check button 510 can be automated were user interface may not be required.

The Send button 612 may be used to send and receive email notifications from the B2B semiconductor data exchange system 104, while the Add New button 614 may enable the customer to add or edit and component. The Copy button 516 may enable the customer to duplicate data and information in a plurality of databases within the network 314 (e.g., process parameters, split lots, etc.). The Replace button 618 may enable a selected component to be replaced by another component. It is understood that the buttons and functions are illustrative, and that many other buttons and functions may be provided. For example, a context sensitive menu may be activated by clicking on a mouse button (not shown) or by using a keyboard (not shown). Accordingly, the interface 600 may be altered as desired to extend its functionality and to maximize customer support.

The B2B semiconductor data exchange system 104 can perform many different tasks. For example, a sub-contractor can define event elements and identification of critical process steps which can be coupled to the manufacturing system of the semiconductor foundry by the B2B semiconductor data exchange system 104. The foundry can access, control, and modify any of the event elements or critical steps by the B2B semiconductor data exchange system 104. Moreover, the sub-contractor can provide real-time feedback of product and process information to the B2B semiconductor data exchange system 104.

The present disclosure has been described relative to a preferred embodiment. Improvements or modifications that become apparent to persons of ordinary skill in the art only after reading this disclosure are deemed within the spirit and scope of the application. It is understood that several modifications, changes and substitutions are intended in the foregoing disclosure and in some instances some features of the disclosure will be employed without a corresponding use of other features. Accordingly, it is appropriate that the appended claims be construed broadly and in a manner consistent with the scope of the disclosure.

1. An enterprise control system for use in an environment for producing semiconductor-related product, the system comprising:
a first mechanism for maintaining an exchange of information between a primary provider and a secondary provider, the information pertaining to the semiconductor-related product;
a second mechanism for collecting the exchanged information;
a third mechanism for collecting event information upon an occurrence of a predetermined event element associated with the semiconductor-related product; and
a fourth mechanism for providing the collected exchanged information and the collected event information to a customer associated with the semiconductor-related product.

2. The system of claim 1 further comprising:
a fifth mechanism for assigning the predetermined event element to the semiconductor-related product at the secondary provider.

3. The system of claim 1 wherein the first mechanism uses a first network for exchanging information between the primary and secondary providers, and the fourth mechanism uses a second network, different from the first network.

4. The system of claim 3 wherein the first mechanism uses a dedicated bi-directional path of the first network, and wherein the second mechanism is for continuously collecting the exchanged information.

5. The system of claim 1 wherein the fourth mechanism is an enterprise control system that includes a customer interface in the form of a web browser.

6. A method of business-to-business exchange between providers in a semiconductor manufacturing environment, the method comprising:
exchanging a product from a primary provider to a secondary provider;
transmitting information associated with the product throughout a virtual fab, wherein the transmission of information occurs continuously and multi-directionally between the providers through the virtual fab;
storing at least a portion of the transmitted information; and
providing the portion of the transmitted information to a customer in response to a customer request.

7. The method of claim 6 wherein the primary provider is a semiconductor fab and the product is a lot of semiconductor wafers.

8. The method of claim 7 further comprising:
assigning event elements to the product through the virtual fab;

9. The method of claim 8 wherein the event elements include process completion at a predetermined check point.

10. The method of claim 8 wherein the event elements of the primary provider and the secondary provider comprise product process steps, the event elements track the product through the virtual fab.

11. The method of claim 7 wherein the information includes product lot identification and product lot history.

12. The method of claim 7, wherein the step of providing uses a service system interface for communicating between a computer system associated with the customer and a computer system associated with the semiconductor fab.

13. A system of business-to-business exchange between entities in a semiconductor manufacturing environment, the system comprising:
a product with exchangeable information interposing a primary provider and a secondary provider;
a plurality of event elements assigned to the product through a virtual fab; and
an enterprise control entity adapted for the exchange of information associated with the product through the virtual fab, the enterprise control entity being adapted to provide multi-directional information manipulation throughout the virtual fab.

14. The system of claim 13 wherein the primary provider is a semiconductor fab facility.

15. The system of claim 13 wherein the secondary provider is a sub-contractor.

16. The system of claim 13 wherein the primary provider is a semiconductor design house.

17. The system of claim 13 wherein the secondary provider is a equipment vendor.

18. The system of claim 13 wherein the event elements of the primary provider and secondary provider comprise product process steps, the event elements track the product through the virtual fab.

19. The system of claim 18 wherein the event elements include manufacturing process checkpoints.

20. The system of claim 13 wherein at least one of the entities is a service system interface for communicating between a computer system associated with a customer and a computer system associated with the semiconductor fab.

21. A software program stored on a recordable medium, the software program being used for tracking and managing a plurality product and information through a semiconductor manufacturing environment, the software program comprising:
instructions for establishing a virtual fab with a plurality of entities, each entity associated with an internal process to a semiconductor fab or an external process to the semiconductor fab;
instructions for a plurality of event elements for tracking the product through the plurality of entities of the virtual fab;
instructions for a communications interface for interacting with a enterprise control entity and the plurality of event elements;
instructions for determining a future location for the product and the associated information through the virtual fab via the enterprise control entity; and
instructions for amending the associated information to the recordable medium through the virtual fab.

22. The software program of claim 21 wherein the plurality of entities include:
at least one entity associated with a primary provider manufacturing executing system in the virtual fab;
at least one entity associated with a secondary provider manufacturing executing system in the virtual fab;
at least one entity associated with a manufacturer of the semiconductor equipment vendor;
at least one entity associated with a manufacturer of the sub-contractor;
at least one entity associated with a manufacturer of the semiconductor design house;
at least one entity associated with a customer of products being manufactured by the semiconductor fab; and
at least one entity associated with engineering support for the either or both of the primary and second manufacturing executing system.
